(19) United States
(12) Patent Application Publication
(10) Pub. No.: US 2019/0251603 A1
(43) Pub. Date: Aug. 15, 2019

(54) SYSTEMS AND METHODS FOR A MACHINE LEARNING BASED PERSONALIZED VIRTUAL STORE WITHIN A VIDEO GAME USING A GAME ENGINE

(71) Applicants: Sampsa Valtteri Jaatinen, San Francisco, CA (US); Stephen Michael Sullivan, San Francisco, CA (US)

(72) Inventors: Sampsa Valtteri Jaatinen, San Francisco, CA (US); Stephen Michael Sullivan, San Francisco, CA (US)

(21) Appl. No.: 16/277,666

(22) Filed: Feb. 15, 2019

Related U.S. Application Data
(60) Provisional application No. 62/631,329, filed on Feb. 15, 2018.

(51) Int. Cl. G06Q 30/02; G06N 20/00; G06N 3/08

(52) U.S. Cl. CPC G06Q 30/0275; G06N 3/08; G06N 20/00

(57) ABSTRACT

Systems and methods for optimizing a Lifetime Value (LTV) of a player of a plurality of computer-implemented games are disclosed. Data is collected from a game of the plurality of games, the data including game event data associated with the player, a playing environment within the game, and store action data. The data is analyzed with a first machine-learning (ML) system to create a time-dependent state representation of the game, the player, and the playing environment. The state representation is provided as input to a second ML system to create and optimize an ML policy over time, the ML policy including a functional relationship proposing a selection of one or more store actions within a store to maximize the LTV. One or more of the store actions chosen from the proposed selection in accordance with the ML policy and implemented within the store environment.

### CROSS REFERENCE TO RELATED APPLICATIONS

This application claims the benefit of U.S. Provisional Application No. 62/631,329, filed Feb. 15, 2018, entitled “SYSTEMS AND METHODS FOR A MACHINE LEARNING BASED PERSONALIZED VIRTUAL STORE WITHIN A VIDEO GAME USING A GAME ENGINE,” which is incorporated by reference herein in its entirety.

### TECHNICAL FIELD

The present invention relates to the field of machine learning for advertising and in-app purchases within video games.

### BACKGROUND OF THE INVENTION

Current methods and systems for advertising and in-application (in-app) purchases in the game industry use static manual coding and fixed logic to determine specific ads and purchases that are displayed to a user. Current implementations have a developer explicitly define placements (e.g., location and time) to show a promotion within a virtual store. To do this the developer writes code that displays items (e.g., a promotion, virtual item, or the like) in a specific layout within a virtual store. Such a virtual store can be made dynamic by connecting the store to a server containing store configurations. A developer can change the configuration on the server to change the display for a player within the store. Changing the configuration on the server is a manual process and requires manual calculation of prices and payouts based on a specific game.

In existing games, due to in-app purchasing pricing and selection of virtual currencies and virtual items being statically set based on a game design, and due to the static nature of the store with respect to predetermined and fixed displaying of virtual items and pricing, there is little to no optimization of item placement with respect to content, position (e.g., layout) and time of display within the store for each particular player.

### BRIEF DESCRIPTION OF THE DRAWINGS

Further features and advantages of the present invention will become apparent from the following detailed description, taken in combination with the appended drawings, in which:

FIG. 1 is a schematic illustrating an dynamic personalized AI store system, in accordance with one embodiment;

FIG. 2 is a flowchart illustrating a method for a dynamic personalized AI store, in accordance with one embodiment;

FIG. 3 is a schematic illustrating a data flow diagram of the dynamic personalized AI store system, in accordance with one embodiment;

FIG. 4 is a schematic illustrating a store layout for the dynamic personalized AI store system, in accordance with one embodiment;

FIG. 5 is a block diagram illustrating an example software architecture, which may be used in conjunction with various hardware architectures described herein; and

FIG. 6 is a block diagram illustrating components of a machine, according to some example embodiments, configured to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details.

Throughout the description herein, the term total revenue should be understood to include a sum of all money from an action of a game player, wherein the action provides revenue to a game developer (or game distributor); the action includes in application (in-app) purchases (IAPs) made by the game player, and paid advertisements viewed by the game player. In accordance with some embodiments, the total revenue generated per player is monitored over time and is also referred to as the “lifetime value” (or LTV) of a player. In accordance with an embodiment the LTV includes advertisement revenue and IAP revenue.

Throughout the description herein, the term ‘store’, or ‘virtual store’ or ‘game store’ should be understood to include a virtual store within a video game or application (e.g., a mobile application). The store displays virtual items which can be purchased by a user (e.g., a video game player). The virtual items typically include virtual currencies to use within a game (e.g., Farm Bucks™ from the Farmville™ game), virtual items (e.g., swords, shields, potions and the like) and promotions (e.g., advertisements for purchasing extensions of a game, advertisements for purchasing other games, and the like). A game player may interact with the store (e.g., while playing a game) to make a purchase (e.g., IAP) using a money transaction. Player purchases within a store are typically made with a virtual wallet which has virtual money (e.g., including cryptocurrencies such as Bitcoin), and/or real money (e.g., via a credit card). The player can then use the purchased items (e.g., game-specific virtual currencies and virtual items) to make progress in a game. A store also typically has a visual layout configuration that defines the orientation, size, and style of all the visual elements of the store including the background, text, advertisements, items for purchase and the like.

In accordance with some embodiments, the methods and systems described herein provide a personalized dynamic in-app and in-game store based on machine learning models that are created to maximize player LTV. Throughout the description herein, the store is referred to as the ‘dynamic personalized AI store’. The methods and systems described herein allow the dynamic personalized AI store to dynamically control (e.g., change over time) a visual layout configuration of the store, displayed items therein, and a price of the displayed items. The dynamic control is based on a plurality of factors including past player behavior, current game state, predicted future player behavior, and predicted future game state. The dynamic personalized AI store is fully adaptable (e.g., based on the factors) with respect to visual layout configuration, displayed items, and item price. The dynamic personalized AI store is personalized based on the factors, so that the dynamic personalized AI store provides a different customized store display (e.g., layout, item choice, and price) for each user and wherein the dynamic personalized AI store changes over time (e.g., by adapting the display) based on user past behavior and predicted next actions for a specific user (e.g., so that each user sees an optimum set of items at an optimum time, as determined by the models).

In accordance with an embodiment, one or more of the visual layout of the store, the choice of displayed items and the price of the items are defined by the methods and systems described herein. In some embodiments, the visual design and layout of the store is defined by a store template. The store template includes data describing the display format (e.g., size or positional layout of items including table cells and grid formats) and displayed content (e.g., details on the type of advertisements, type of in-app purchases, or type virtual items). The display format data includes data describing the scrolling direction of items within the store display (e.g., up/down vs. left/right), data describing highlighted specials for an item to be displayed within the store display (e.g., adding an icon to an item display to indicate a sale), data describing the color schemes for the store display, and data describing the order of items displayed within the store. A template could be specific to a scenario, wherein the scenario includes a geographic region, a game type (e.g., first person shooter, strategy, role playing, and the like), and a time of year (e.g., summer, winter, Christmas, and the like). For example, a store template for a first person shooter game in South America could be different from a template for a strategy game in Asia. Accordingly, a player located in South America would be presented with a different store display and content than the display and content presented to a player in Asia. In accordance with an embodiment the methods and systems described herein can change the parameters of the template itself (e.g., changing the scrolling direction). In accordance with an embodiment, the systems and methods described herein change elements displayed within the store template over time. For example, displayed items and the order of the items can be changed over time by the systems and methods described herein.

In example embodiments, systems and methods for optimizing a Lifetime Value (LTV) of a player of a plurality of computer-implemented games are disclosed. Data is collected from a game of the plurality of games, the data including game event data associated with the player, a playing environment within the game, and store action data. The data is analyzed with a first machine-learning (ML) system to create a time-dependent state representation of the game, the player, and the playing environment. The state representation is provided as input to a second ML system to create and optimize an ML policy over time, the ML policy including a functional relationship proposing a selection of one or more store actions within a store to maximize the LTV. One or more of the store actions chosen from the proposed selection in accordance with the ML policy and implemented within the store environment.

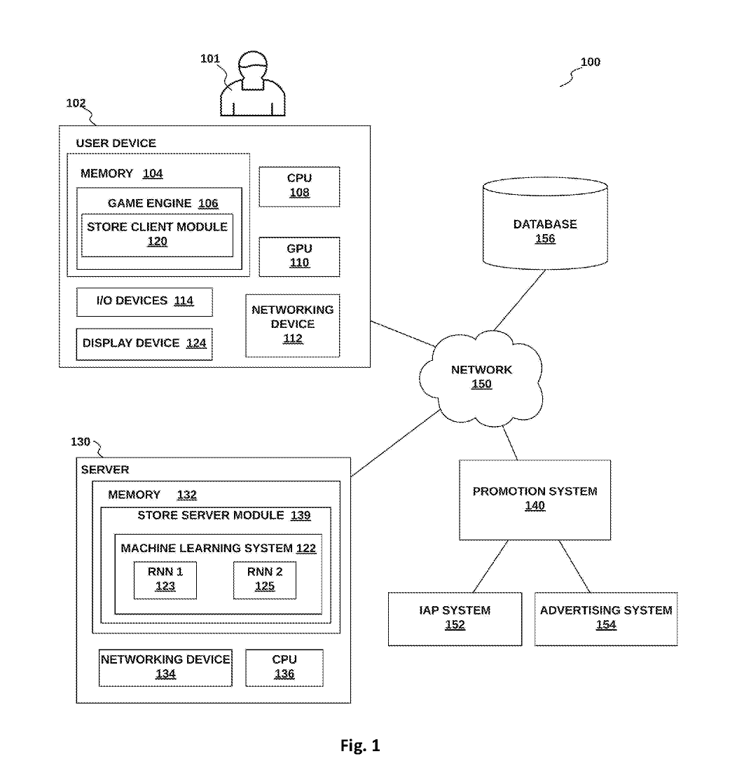

Turning now to the drawings, systems and methods for maximizing the LTV of a player by optimizing the prices, content and visual layout of a virtual store for an individual game player using machine learning in accordance with embodiments of the invention are illustrated. FIG. 1 is a diagram of an example dynamic personalized AI store system 100 and associated devices configured to provide a dynamic personalized AI store within a game for a game player. In the example embodiment, the dynamic personalized AI store system 100 includes a user device 102 operated by a user 101 (e.g. a game player), a server 130, a database 156, and a promotion system 140 all coupled in networked communication via a network 150 (e.g., a cellular network, a Wi-Fi network, the Internet, a wired local network, and the like). The user device 102 is a computing device capable of providing a gameplay experience (e.g., video game) to the user 101. In some embodiments, the user device 102 is a mobile computing device, such as a smartphone or a tablet computer and in other embodiments the user device 102 is a desktop computer or video game console. The game can be any type of video game, including 2 dimensional (2D) games, 3-dimensional (3D) games, virtual reality (VR) games, augmented reality (AR) games and the like. Although not separately shown in FIG. 1, in practice the system 100 would have a plurality of user devices 102 connected to the network 150.

In the example embodiment, the user device 102 includes one or more central processing units (CPUs) 108, and graphics processing units (GPUs) 110. The user device 102 also includes one or more networking devices 112 (e.g., wired or wireless network adapters) for communicating across the network 150. The user device 102 also includes one or more input devices 114 such as, for example, a keyboard or keypad, mouse, joystick (or other game play device), pointing device, touch screen, or handheld device (e.g., hand motion tracking device). The user device 102 further includes one or more display devices 124, such as a touchscreen of a tablet or smartphone, or lenses or visor of a VR or AR head mounted display (HMD), which may be configured to display virtual objects to the user 101 in conjunction with a real-world view. The display device 124 is driven or controlled by the one or more GPUs 110. The GPU 110 processes aspects of graphical output that assists in speeding up rendering of output through the display device 124.

The user device 102 also includes a memory 104 configured to store a game engine 106 (e.g., executed by the CPU 108 or GPU 110) that communicates with the display device 124 and also with other hardware such as the input device(s) 114 to present a game (e.g., a video game) to the user 101. The game engine 106 can include a physics engine, collision detection, rendering, networking, sound, animation, and the like in order to provide the user with a video game environment. The game engine 106 includes a dynamic personalized AI store client module (“client module”) 120 that provides various dynamic personalized AI store functionality as described herein. Each of the dynamic personalized AI store client module 120, and game engine 106 include computer-executable instructions residing in the memory 104 that are executed by the CPU 108 or the GPU 110 during operation. The dynamic personalized AI store client module 120 may be integrated directly within the game engine 106 or may be implemented as an external piece of software (e.g., a plug-in).

In accordance with an embodiment, the server 130 includes a CPU 136 and a networking device 134 for communicating across the network 150. The server 130 also includes a memory 132 for storing a dynamic personalized AI store server module (“server module”) 139 that provides various dynamic personalized AI store functionality as described herein. The dynamic personalized AI store server module 139 includes computer-executable instructions residing in the memory 132 that are executed by the CPU 136 during operation. The memory 132 includes a machine learning system 122 that includes a first recurrent neural network (RNN-1) 123, and a second recurrent neural network (RNN-2) 125 which are implemented within, or otherwise in communication with, the dynamic personalized AI store server module 139. In accordance with some embodiments, the neural network architecture for RNN-1 123 can be a fully connected feed forward network using rectifier linear units or logistic units or a combination thereof. The neural network RNN-1 123 can also assume a form of recurrent neural network employing long short-term memory units (LSTM, gated recurrent unit (GRU) or equivalent. Similarly, the neural network architecture for RNN-2 125 can be a fully connected feed forward network using rectifier linear units or logistic units or a combination thereof. The neural network RNN-2 125 can also assume a form of recurrent neural network employing a long short-term memory units (LSTM), gated recurrent unit (GRU) or equivalent. In still other embodiments, the recurrent neural networks (RNN-1 and RNN-2) can be replaced by any other type of neural network with memory. In accordance with an embodiment, and described herein, RNN-1 is used to describe and define a player state for a game player over time. In accordance with an embodiment, RNN-2 uses the output from RNN-1 and creates a store action policy as described herein. During operation, the dynamic personalized AI store client module 120 and the dynamic personalized AI store server module 139 perform the various dynamic personalized AI store functionalities described herein. More specifically, in some embodiments, some functionality may be implemented within the client module 120 and other functionality may be implemented within the server module 139. For example, in accordance with an embodiment, the client module 120, executing on the user device 102, may be configured to monitor the game play environment to measure interactions of the user 101 with the game environment and may also be configured to include the store template and fill the template with information received from the server module 139. In accordance with an embodiment the client module 120 fills the store template according to directions (e.g., instructions) received from the server module 139.

In accordance with some embodiments the dynamic personalized AI store system 100 includes a promotion system 140 that can include or communicate with an advertising system 154 and an IAP system 152. The advertising system 154 allows an advertising entity to make advertisements available for the store (e.g., via an auction controlled by the store server module 139). An advertising entity is any group, company, organization or the like that provides advertisements to the advertising system (e.g., including game production studios, movie production studios, car manufacturers, software companies and more). The IAP system 152 allows a selling entity (e.g., game development companies) to make items available for purchase in the store (e.g., via an auction controlled by the store server module 139). A selling entity is any group, company, organization or the like that provides items for purchase to the IAP system (e.g., including game production studios, movie production studios, car manufacturers, software companies and more). In some embodiments, a group, company, organization or the like may be both an advertising entity and a IAP entity.

In accordance with an embodiment, the client module 120, executing on the user device 102, may be configured to monitor the game play environment to measure interactions of the user 101 with the game environment (e.g., the store) and game logic. Throughout the description herein, the interactions between the user 101 and the game environment and game logic will be referred to as ‘game events’. The game events include events related to game play and progress within a game (e.g., starting a game, finishing a game level, finishing a complete game, finding a secret room, killing an enemy, passing a specific point on a game level, stopping a game, clicking a mouse button during a game, losing a level of a game, quitting a level of a game, skipping a level of a game, increasing in rank or skill level in a game, and the like). The game events include monetization events related to revenue and a game economy (e.g., including purchasing an asset within a game, purchasing a game, purchasing a virtual asset within the store, and the like). The game events include ad-engagement events (e.g., starting, finishing and skipping viewing an advertisement within the store, viewing an advertisement within a gameplay environment, and the like). The underlying mechanism for defining an event (e.g., the parameters that allow an interaction to be defined as an event) is created in the game code by a creator of the game (e.g., a game developer). In accordance with an embodiment, in order to maximize the effectiveness of the dynamic personalized AI store system, it is expected that a developer include a plurality of specific game events in a game. When a game is being played, the game events which are triggered by a user 101 are logged from the user device 102 to a database 156.

Throughout the description herein the term ‘store actions’ are understood to include actions taken by the store client module 120 (and potential actions the store client module 120 can take in a future) and actions taken by the store server module 139 (and potential actions the store server module 139 can take in a future). A store action can include any action that changes the display in the store whereby the change is made by the store server module 139 or store client module 120 (for example, displaying an advertisement for a video game, and displaying a specific IAP such as digital game currency and game objects). A store action can also include any action that changes the store template whereby the change is made by the store server module 139 or store client module 120 (e.g., changing the layout from table cells to grid, changing the scrolling direction, and the like). In accordance with an embodiment, store action data is data which describes a store action. Store action data can include the following: display timing data that describes timing aspects associated with the displaying of the store action (e.g., including information on the time of display for the store action, which can include a start time, a duration, and the like); display location data that describes a location within the store where content (e.g., the advertisement, the IAP) for the store action is displayed; display format data that describes aspects of the visual format (e.g., size of items, layout of items, scrolling direction for items, color schemes, order of items, and the like) of the display of the store action; and content data describing an item for display (e.g., details on advertisements, in-app purchases, virtual items and the like associated with the item). The data within the store action is determined dynamically (e.g., during game play) by the methods and systems herein.

Throughout the description herein the term ‘reward’ will be used to refer to any monetary revenue received by the store from a user, whereby the revenue is associated with a store action (e.g., revenue received through a promotion created by a store action, revenue received after a store display is created by a store action, revenue received after a store display is modified by a store action, revenue received for a virtual item added to the store by a store action, and the like). A store action is associated with a reward (including a null reward whereby no revenue is received), wherein the reward is the revenue the store client module 120 receives (e.g., through a 3^{rd}-party payment processing service) from the user 101 due to the store action.

In accordance with an embodiment, RNN-2 125 creates a store action policy, which is a policy that determines the relationship between game events, store actions and rewards. The store action policy includes information that describes a relationship (e.g., a mapping) between player states, game events, store actions and rewards. The store action policy can include rules, heuristics, and probabilities for matching a player state (including game events) with one or more store actions in order to maximize a future reward. The store action policy is an output of RNN-2 125 and is used as a guide (e.g. set of rules) by the dynamic personalized AI store server module 139 to decide on a specific store action to initiate given a particular player state (defined below) and a context (e.g. specific game environment). The machine learning system 122 uses RNN-2 125 in a reinforcement learning scenario in order for RNN-2 125 to create the policy and then continuously update the policy based on game events over time.

In accordance with an embodiment, store action data is provided by the promotion system 140. The promotion system 140 is in communication with the dynamic personalized AI store server module 139 and provides access to store action data that may be provided by the advertising system 154 and the IAP system 152. In addition to providing access to the store action data, the promotion system 140 provides an auctioning service that allows an entity (e.g., a company, an organization, a group, etc.) to bid on an impression of a store action. A store action impression is a placeholder for a store action which an entity (e.g., game development company) can bid on during an auction. A store action impression is a store action that comprises store action data which is only partially complete or which includes temporary values. A winning entity of an auction wins the privilege of completing the store action data within the impression. In accordance with an embodiment, the store server module 139 provides an auction for the impression. During operation of an auction, one or more entities would be on the demand side of the auction (e.g., bidding for impressions) and the dynamic personalized AI store server module 139 would be on the supply side of the auction (e.g., providing store action impressions). During operation of an auction, the one or more entities are provided with an impression (e.g., from the server module 139) and submit bids to compete for the impression. A bid includes monetary value (e.g., the amount an entity is willing to pay for the store action impression) and information on the virtual item to be placed in the store action (e.g., information on an advertisement, information on an IAP item, and the like). The dynamic personalized AI store server module 139 receives bids from the promotion system 140 and chooses (e.g., using the store action policy from the machine learning system 122) a bid that the store action policy determines is the most beneficial (e.g., maximizes the LTV of the user) at the moment of the reception. The receiving of the bids may have a time limit. The dynamic personalized AI store server module 139 then requests from the promotion system 140 the data for the specific impression that was chosen (e.g., the bid that won the auction). Once the dynamic personalized AI store server module 139 receives the data from the impression that won, it uses the data to complete the store action by placing the impression (e.g., add, IAP, virtual item) in the store according to the specific data of the impression and the store action policy. The server module 139 can choose any valid bid (e.g., it is not bound to choose a bid with the highest monetary value). In accordance with an embodiment, the module 139 employs the store action policy from RNN-2 to choose a bid whereby the choice of bid is based on a prediction from RNN-2 that the choice will result in a maximized future potential LTV.

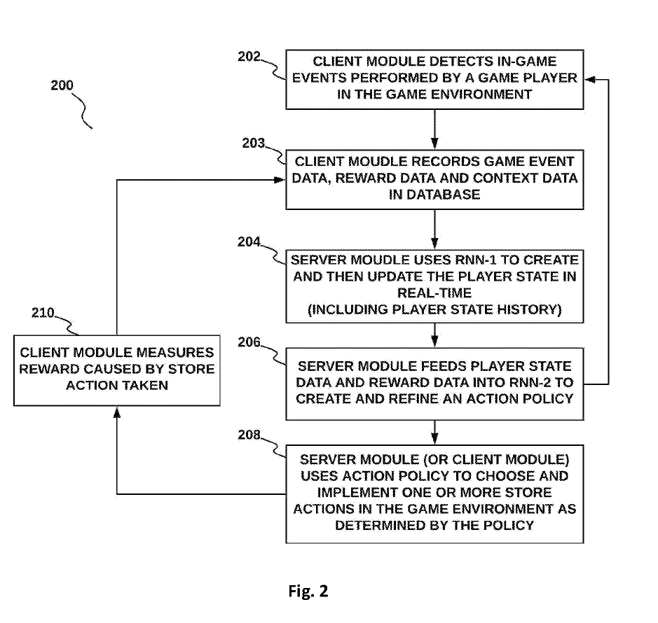

In accordance with an embodiment, FIG. 2 shows a flowchart for a method 200 for creating a dynamic personalized AI store using the dynamic personalized AI store system 100. In reference to FIG. 2, during operation 202, the dynamic personalized AI store client module 120 is configured to measure and record game events performed by the game player in the game environment (e.g., making in-game or in-app purchases, purchasing a second game while in a first game, finishing a game level, etc.). The dynamic personalized AI store client module 120 is also configured to record all rewards for a player 101. In addition to recording the game event information, the client module 120 records data regarding context information for the player, wherein the context data includes information not related to the actions of a player 101. For example, the context data includes: device type used by the player, day of the week played, time of the day played, country where game is played, title of the game, and the like. At operation 203 of the method 200, the game event data, reward data and context data are recorded by the client module 120 in the database 156. In accordance with an embodiment, there is provided a logging system (not separately shown in the figures) to record the game event, data, reward data, and context data in the database 156. At operation 204 of the method 200, the dynamic personalized AI store server module 139 communicates with the database 156 to extract the game event data, reward data, and context data for the game player 101. As part of operation 204, the dynamic personalized AI store server module 139 provides the extracted data to RNN-1 in order for RNN-1 to create representations from the data. The representations can include a time dependent representation of a player state, which includes a representation for context data, and a representation for store actions. The output of RNN-1 123 includes a numerical representation or description of a player state (which includes game environment data and store action data) that is provided to RNN-2 125. The process of generating representations for the player state and reward data can include the use of natural language processing (NLP). For example, a NLP system can be used to analyze a text description of a game (e.g., as acquired from an application store) and generate a numerical representation of the description. Similarly, a NLP system or a neural network can be used to generate a numerical representation of a promotion asset (e.g., including advertisements and IAP) from the promotion system 140. The promotion assets might include multimedia such as images and videos which can be converted to numerical representations. In addition to machine learned representations, other non-machine learned numerical representations can be used (e.g., the number of times different events occur per time interval). As an example of operation 204, the dynamic personalized AI store server module 139 provides data to RNN-1 123 which uses the data to define a first state at a first time (e.g. state S(t) which changes over time (t)) for the game player 101. In some embodiments, the state includes a history of previous game events recorded by the client module 120 for the player 101. In accordance with another embodiment, the state includes a time-ordered series of game events and context information; for example:
Event 1) At time t1, player started game ‘A’
Event 2) At time t2, player watched ad ‘123’ in game ‘A’
Event 3) At time t3, player bought IAP item ‘ABC’ in game ‘A’
Event 4) At time t4, player ended game ‘A’
Event 5) At time t5, player started game ‘B’
Event 6) . . . .

While the above is shown in text format for convenience, the data as produced by RNN-1 123 could be in numerical format. Referring back to FIG. 2, and in accordance with an embodiment, at operation 206 the server module 139 feeds a player state (e.g., player state data from the output of RNN-1 123) and reward data into the machine learning system 122 that includes the second neural network RNN-2 125. The second neural network RNN-2 125 uses the state data from RNN-1 123 and the reward data to determine and output a store action policy to be used by the server module 139. For example, the RNN-2 125 can be configured to provide (e.g., as part of the policy) an estimation of future state changes based on a current store action chosen by the dynamic personalized AI store server module 139. At operation 208, the dynamic personalized AI store server module 139 uses the store action policy and current state data (e.g., first state data) to choose one or more store actions in the virtual store environment. The store action policy is used by the dynamic personalized AI store server module 139 as a guide to make the optimum decision at each moment (e.g. in real-time) taking into account past events (e.g., previous player states and rewards) and future impacts (e.g., predicted changes in the player state and predicted future rewards). The decision includes the choice of store actions to implement given a current player state, game context and store action policy. The dynamic personalized AI store server module 139 uses RNN-2 125 within the machine learning system 122 to learn (e.g., over time) an optimum store action policy for a player state and environmental context. The dynamic personalized AI store server module 139 optimizes the store action policy on a per player basis. For example, the server module 139 can adapt the configuration of a store template over time as the system 100 receives more information describing the interaction of a player with a game.

In accordance with an embodiment, during operation 208 of the method 200, the client module 120 implements the store action (e.g., places a specific advertisement within the store at a specific time and place) chosen by the server module 139 using the policy. In the embodiment, the client module 120 implements the decision (e.g., the chosen store action) made by the server module 139.

In accordance with another embodiment, during operation 208 of the method 200, the client module 120 uses the store action policy and state data (e.g., the first state) to choose one or more store actions, and to subsequently implement (e.g., place) the chosen one or more store actions in the game store. In the embodiment, the client module 120 both chooses and implements the store action.

In accordance with an embodiment, at operation 210 of the method 200, as part of the reinforcement learning with RNN-2 125, the client module 120 records the reward caused by the store action and feeds it back to RNN-2 (e.g. via the database 156).

In accordance with an embodiment the dynamic personalized AI store server module 139 uses reinforcement learning within the method 200 to create a machine learning model (e.g., within RNN-2 125) to learn a policy connecting a player state, each store action, predicted future rewards and predicted future player states. In accordance with some embodiments, the model is represented by values of parameters within the neural network RNN-2 125; wherein the values include weights and biases for neurons (e.g., nodes) within RNN-2 125. The dynamic personalized AI store server module 139 creates (e.g., via recursion of reinforcement learning of RNN-2 125) an evolving store action policy for a player so that over time the store client module receives (e.g., via a 3^{rd}-party payment processing service) the maximum amount of monetary rewards from the player. The system 100 continuously monitors the response (e.g., to store actions) of a user 101 and updates the model (e.g., by changing the weights and biases of RNN-2 125 via reinforcement learning) and policy according to any new data; including new users, new games, new devices and the like. Furthermore, with the use of the player state (e.g., with player state history) and RNN-1 123 which uses memory of past player states (e.g., using LSTM), the dynamic personalized AI store server module 139 makes decisions with the policy on an individual player level and in an ongoing and dynamic way (e.g., the policy determines the best set of store actions with a specific user 101, at a specific time and in a specific context).

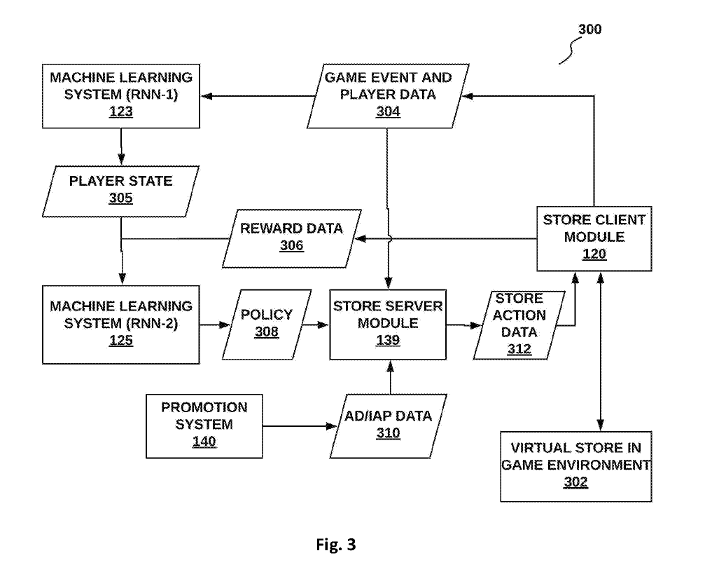

FIG. 3 is a data flow diagram for the dynamic personalized AI store system 100. Some elements of the system 100 (e.g. the database 156) are not shown. With reference to FIG. 3, the dynamic personalized AI store client module 120 monitors the game environment 302 on the user device 102 in order to extract data about the game events 304, context data, and data about rewards 306. The extracted data 304 is provided to RNN-1 123 of the machine learning system 122 in order for RNN-1 123 to determine a player state 305. The state data 305 and the reward data 306 are provided to RNN-2 125 of the machine learning system 122 to create and maintain a policy 308 for the store server module 139. The dynamic personalized AI store server module 139 uses the policy 308 to make decisions on the placement of store actions 312 in the virtual store within the game environment 302 (the placements of store actions may be implemented by the client module 120 on the user device 102). The store server module 139 uses the policy 308 to make decisions about the specific advertisement/IAP data 310 from the promotion system 140 to include in the one or more store actions 312 that are exposed (e.g., via the virtual store) to the user in the game environment 302. The decision process may include an auction (e.g., as described herein with respect to the process of an auction) whereby a specific store action is chosen from many available store actions. The ad/IAP data 310 includes bidding data, advertising data, and AIP data for the auction (e.g., within an impression).

The client module 120 shows promotions (e.g., via store actions chosen by the server module 139) in response to game events and previous purchases within the store, and the system 100 measures the response (e.g., via monetary rewards) from a user 101 and uses the responses to create a model (e.g., RNN-2 125 creates a model for the user and game environment) and a policy for making decisions regarding the placement of store actions.

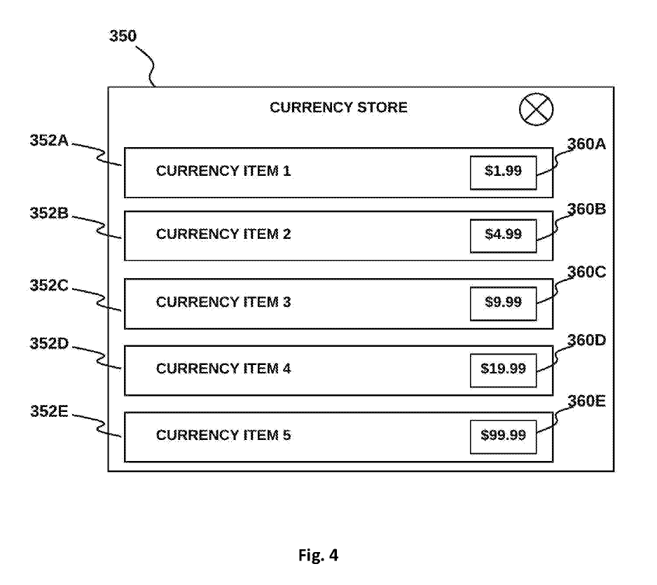

In accordance with an embodiment, FIG. 4 shows an illustration of an example store configuration for a currency store which could be shown to a player during a video game. In the figure, a user interface element 350 shows the store containing five different currency items 352A-E. Each currency item 352A-E has a respective price 360A-E shown in the store. The order of the currency items 352A-E, the price of the items 360A-E and the visual layout of the user interface is determined by the system 100. In the example embodiment shown, the currency items 352A-E are not listed by order of increasing price, but rather they are positioned by the system 100 in order to maximize the LTV of the particular player to which the store is displayed. A different player would have a different store displayed. For example, the different store could have different currency items, and different prices and be displayed in a different order or visual layout.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

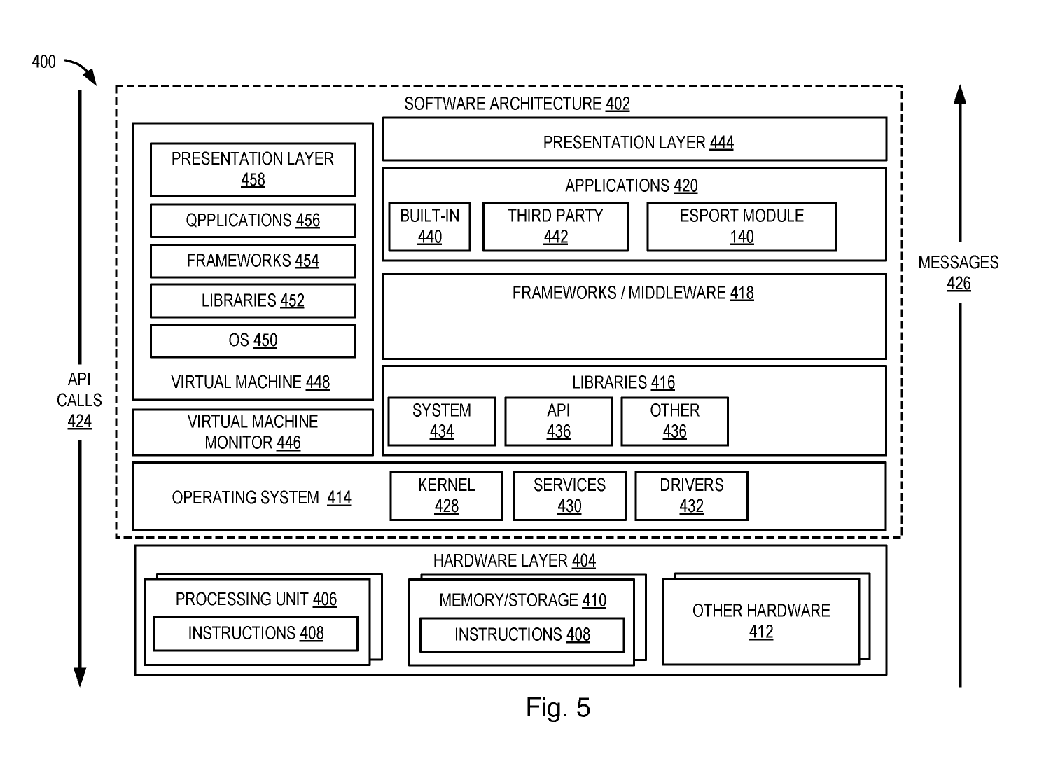

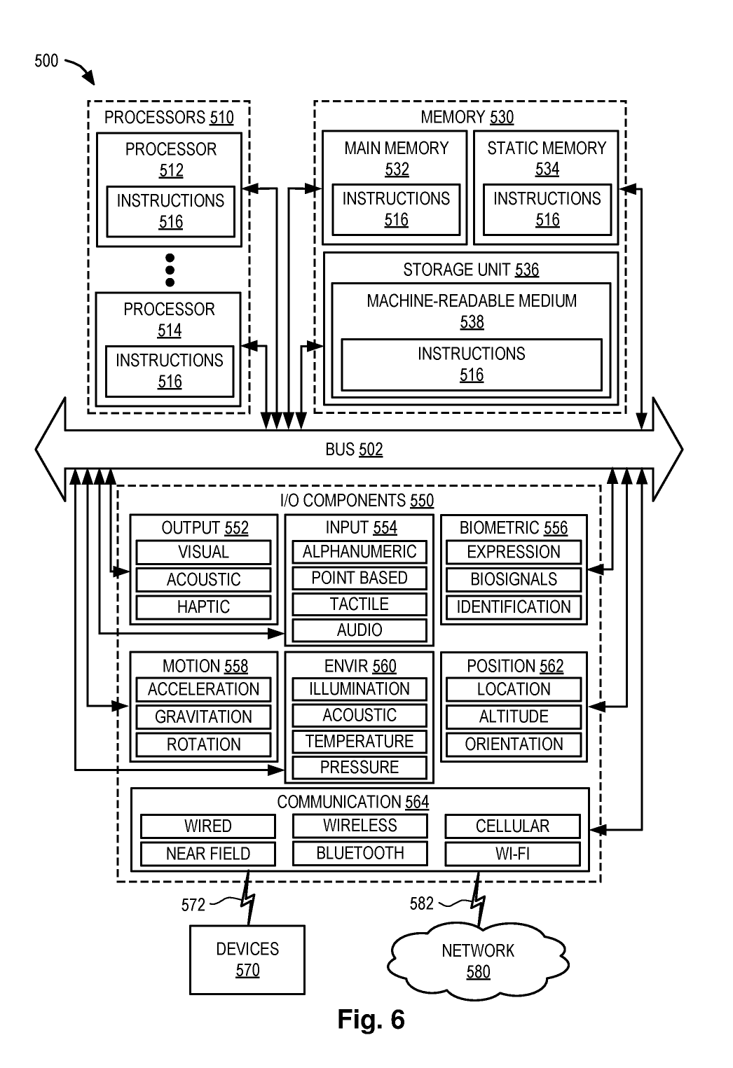

FIG. 5 is a block diagram illustrating an example software architecture 402, which may be used in conjunction with various hardware architectures herein described. FIG. 5 is a non-limiting example of a software architecture and it will be appreciated that many other architectures may be implemented to facilitate the functionality described herein. The software architecture 402 may execute on hardware such as machine 500 of FIG. 6 that includes, among other things, processors 510, memory 530, and input/output (I/O) components 550. A representative hardware layer 404 is illustrated and can represent, for example, the machine 500 of FIG. 6. The representative hardware layer 404 includes a processing unit 406 having associated executable instructions 408. The executable instructions 408 represent the executable instructions of the software architecture 402, including implementation of the methods, modules and so forth described herein. The hardware layer 404 also includes memory and/or storage modules shown as memory/storage 410, which also have the executable instructions 408. The hardware layer 404 may also comprise other hardware 412.

In the example architecture of FIG. 5, the software architecture 402 may be conceptualized as a stack of layers where each layer provides particular functionality. For example, the software architecture 402 may include layers such as an operating system 414, libraries 416, frameworks or middleware 418, applications 420 and a presentation layer 444. Operationally, the applications 420 and/or other components within the layers may invoke application programming interface (API) calls 424 through the software stack and receive a response as messages 426. The layers illustrated are representative in nature and not all software architectures have all layers. For example, some mobile or special purpose operating systems may not provide the frameworks/middleware 418, while others may provide such a layer. Other software architectures may include additional or different layers.

The operating system 414 may manage hardware resources and provide common services. The operating system 414 may include, for example, a kernel 428, services 430, and drivers 432. The kernel 428 may act as an abstraction layer between the hardware and the other software layers. For example, the kernel 428 may be responsible for memory management, processor management (e.g., scheduling), component management, networking, security settings, and so on. The services 430 may provide other common services for the other software layers. The drivers 432 may be responsible for controlling or interfacing with the underlying hardware. For instance, the drivers 432 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 416 may provide a common infrastructure that may be used by the applications 420 and/or other components and/or layers. The libraries 416 typically provide functionality that allows other software modules to perform tasks in an easier fashion than by interfacing directly with the underlying operating system 414 functionality (e.g., kernel 428, services 430, and/or drivers 432). The libraries 416 may include system libraries 434 (e.g., C standard library) that may provide functions such as memory allocation functions, string manipulation functions, mathematic functions, and the like. In addition, the libraries 416 may include API libraries 436 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 416 may also include a wide variety of other libraries 438 to provide many other APIs to the applications 420 and other software components/modules.

The frameworks 418 (also sometimes referred to as middleware) provide a higher-level common infrastructure that may be used by the applications 420 and/or other software components/modules. For example, the frameworks/middleware 418 may provide various graphic user interface (GUI) functions, high-level resource management, high-level location services, and so forth. The frameworks/middleware 418 may provide a broad spectrum of other APIs that may be used by the applications 420 and/or other software components/modules, some of which may be specific to a particular operating system or platform.

The applications 420 include built-in applications 440 and/or third-party applications 442. Examples of representative built-in applications 440 may include, but are not limited to, a contacts application, a browser application, a book reader application, a location application, a media application, a messaging application, and/or a game application. The third-party applications 442 may include an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 442 may invoke the API calls 424 provided by the mobile operating system such as the operating system 414 to facilitate functionality described herein.

The applications 420 may use built-in operating system functions (e.g., kernel 428, services 430, and/or drivers 432), libraries 416, or frameworks/middleware 418 to create user interfaces to interact with users of the system. Alternatively, or additionally, in some systems interactions with a user may occur through a presentation layer, such as the presentation layer 444. In these systems, the application/module “logic” can be separated from the aspects of the application/module that interact with a user.

Some software architectures use virtual machines. In the example of FIG. 5, this is illustrated by a virtual machine 448. The virtual machine 448 creates a software environment where applications/modules can execute as if they were executing on a hardware machine (such as the machine 500 of FIG. 5, for example). The virtual machine 448 is casted by a caster operating system (e.g., operating system 414 in FIG. 5) and typically, although not always, has a virtual machine monitor 446, which manages the operation of the virtual machine 448 as well as the interface with the caster operating system (e.g., operating system 414). A software architecture executes within the virtual machine 448 such as an operating system (OS) 450, libraries 452, frameworks 454, applications 456, and/or a presentation layer 458. These layers of software architecture executing within the virtual machine 448 can be the same as corresponding layers previously described or may be different.

FIG. 6 is a block diagram illustrating components of a machine 500, according to some example embodiments, able to read instructions from a machine-readable medium (e.g., a machine-readable storage medium) and perform any one or more of the methodologies discussed herein. Specifically, FIG. 6 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. As such, the instructions 516 may be used to implement modules or components described herein. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines that individually or jointly execute the instructions 516 to perform any one or more of the methodologies discussed herein.

The machine 500 may include processors 510, memory 530, and input/output (I/O) components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 512 and a processor 514 that may execute the instructions 516. The term “processor” is intended to include multi-core processor that may comprise two or more independent processors (sometimes referred to as “cores”) that may execute instructions contemporaneously. Although FIG. 6 shows multiple processors, the machine 500 may include a single processor with a single core, a single processor with multiple cores (e.g., a multi-core processor), multiple processors with a single core, multiple processors with multiples cores, or any combination thereof.

The memory 530 may include a memory, such as a main memory 532, a static memory 534, or other memory storage, and a storage unit 536, both accessible to the processors 510 such as via the bus 502. The storage unit 536 and memory 532, 534 store the instructions 516 embodying any one or more of the methodologies or functions described herein. The instructions 516 may also reside, completely or partially, within the memory 532, 534, within the storage unit 536, within at least one of the processors 510 (e.g., within the processor's cache memory), or any suitable combination thereof, during execution thereof by the machine 500. Accordingly, the memory 532, 534, the storage unit 536, and the memory of processors 510 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 550 may include a wide variety of components to receive input, provide output, produce output, transmit information, exchange information, capture measurements, and so on. The specific input/output (I/O) components 550 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 550 may include many other components that are not shown in FIG. 6. The input/output (I/O) components 550 are grouped according to functionality merely for simplifying the following discussion and the grouping is in no way limiting. In various example embodiments, the input/output (I/O) components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the input/output (I/O) components 550 may include biometric components 556, motion components 558, environment components 560, or position components 562 among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental environment components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 550 may include communication components 564 operable to couple the machine 500 to a network 580 or devices 570 via a coupling 582 and a coupling 572 respectively. For example, the communication components 564 may include a network interface component or other suitable device to interface with the network 580. In further examples, communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a Universal Serial Bus (USB)).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

I/We claim:

1. A system comprising:
one or more computer processors;
one or more computer memories;
a dynamic personalized AI store module incorporated into the one or more computer memories, the AI store module configuring the one or more computer processors to perform operations for optimizing a Lifetime Value (LTV) of a player of a plurality of computer-implemented games, the operations comprising:
collecting data from a game of the plurality of games, the data including game event data associated with the player, a playing environment within the game, and store action data;
analyzing the data with a first machine-learning (ML) system to create a time-dependent state representation of the game, the player, and the playing environment;
providing the state representation as input to a second ML system to create and optimize an ML policy over time, the ML policy including a functional relationship proposing a selection of one or more store actions within a store to maximize the LTV; and
choosing and implementing within the store environment one or more of the store actions from the proposed selection in accordance with the ML policy.

2. The system of claim 1, wherein store actions include one or more of changing a price, changing a visual layout, or changing content of one or more virtual items within a store template, the template providing rules for the price, the visual layout and the content.

3. The system of claim 2, wherein the second ML system is used to modify the store template.

4. The system of claim 1, wherein the choosing of the one or more of the store actions includes operations for performing an auction, the operations for performing the auction comprising:
providing an environment for the auction wherein a plurality of advertising entities and a plurality of IAP entities place one or more bids for a placeholder impression, the placeholder impression including instructions on defining a price, a visual layout, and content within a store action;
choosing one of the one or more bids so as to optimize the LTV in accordance with the policy; and
extracting the instructions for the store action for the chosen bid.

5. The system of claim 1, wherein the first ML system or the second ML system is a recurrent neural network with long short-term memory and gated recurrent units.

6. The system of claim 1, wherein the playing environment includes one of a 3D virtual environment, a 2D virtual environment, or an augmented reality environment.

7. The system of claim 1, wherein the state representation includes a history of time-ordered game events and context data for the player.

8. The system of claim 1, wherein the game event data includes at least one of device and operating system (OS) information, player gameplay behavior data, application performance data, or game metadata.

9. The system of claim 1, wherein the store action data comprises data that describes the store action, the store action including at least one of changing a price, changing a visual layout, or changing content of one or more virtual items within a store

10. A method comprising:
performing operations for optimizing a Lifetime Value (LTV) of a player of a plurality of computer-implemented games, the operations comprising:
collecting data from a game of the plurality of games, the data including game event data associated with the player, a playing environment within the game, and store action data;
analyzing the data with a first machine-learning (ML) system to create a time-dependent state representation of the game, the player, and the playing environment;
providing the state representation as input to a second ML system to create and optimize an ML policy over time, the ML policy including a functional relationship proposing a selection of one or more store actions within a store to maximize the LTV; and
choosing and implementing within the store environment one or more of the store actions from the proposed selection in accordance with the ML policy.

11. The method of claim 10, wherein store actions include one or more of changing a price, changing a visual layout, or changing content of one or more virtual items within a store template, the template providing rules for the price, the visual layout and the content.

12. The method of claim 11, wherein the second ML system is used to modify the store template.

13. The method of claim 10, wherein the choosing of the one or more of the store actions includes operations for performing an auction, the operations for performing the auction comprising:
providing an environment for the auction wherein a plurality of advertising entities and a plurality of IAP entities place one or more bids for a placeholder impression, the placeholder impression including instructions on defining a price, a visual layout, and content within a store action;
choosing one of the one or more bids so as to optimize the LTV in accordance with the policy; and
extracting the instructions for the store action for the chosen bid.

14. The method of claim 10, wherein the first ML system or the second ML system is a recurrent neural network with long short-term memory and gated recurrent units.

15. The method of claim 10, wherein the playing environment includes one of a 3D virtual environment, a 2D virtual environment, or an augmented reality environment.

16. The method of claim 10, wherein the state representation includes a history of time-ordered game events and context data for the player.

17. A non-transitory machine-readable medium having a set of instructions stored thereon, the set of instructions configuring one or more computer processors to perform operations for optimizing a Lifetime Value (LTV) of a player of a plurality of computer-implemented games, the operations comprising:
collecting data from a game of the plurality of games, the data including game event data associated with the player, a playing environment within the game, and store action data;
analyzing the data with a first machine-learning (ML) system to create a time-dependent state representation of the game, the player, and the playing environment;
providing the state representation as input to a second ML system to create and optimize an ML policy over time, the ML policy including a functional relationship proposing a selection of one or more store actions within a store to maximize the LTV; and
choosing and implementing within the store environment one or more of the store actions from the proposed selection in accordance with the ML policy.

18. The non-transitory machine-readable medium of claim 17, wherein store actions include one or more of changing a price, changing a visual layout, or changing content of one or more virtual items within a store template, the template providing rules for the price, the visual layout and the content.

19. The non-transitory machine-readable medium of claim 18, wherein the second ML system is used to modify the store template.

20. The non-transitory machine-readable medium of claim 17, wherein the choosing of the one or more of the store actions includes operations for performing an auction, the operations for performing the auction comprising:
providing an environment for the auction wherein a plurality of advertising entities and a plurality of IAP entities place one or more bids for a placeholder impression, the placeholder impression including instructions on defining a price, a visual layout, and content within a store action;
choosing one of the one or more bids so as to optimize the LTV in accordance with the policy; and
extracting the instructions for the store action for the chosen bid.
